(19) United States
(12) Patent Application Publication
(10) Pub. No.: US 2015/0197069 A1
(43) Pub. Date: Jul. 16, 2015

(54) CARRIER FOR A VEHICLE INTERIOR TRIM PART, A VEHICLE INTERIOR TRIM PART, AS WELL AS A METHOD FOR MANUFACTURING A CARRIER

(71) Applicant: Faurecia Innenraum Systeme GmbH, Hagenbach (DE)

(72) Inventors: Guillaume Basquin, Wissembourg (FR); Lidia Chapeau, Karlsruhe (DE)

(21) Appl. No.: 14/597,843

(22) Filed: Jan. 15, 2015

(30) Foreign Application Priority Data
Jan. 16, 2014 (DE) 102014200682.1

(51) Int. Cl. B32B 5/12; B29C 43/20; B32B 25/10

(52) U.S. Cl. CPC B32B 5/12; B32B 25/10; B29C 43/203; B32B 2262/06; B32B 2605/003; B29K 2101/12

(57) ABSTRACT

A carrier having at least one thermoplastic material, at least one first layer which is formed from a pressed fiber mat and is with fibers of a random orientation, and at least one second layer with aligned fibers.

### TECHNICAL FIELD

The invention relates to a carrier for a vehicle interior trim part, to a vehicle interior trim part as well as to a method for manufacturing a carrier.

### BACKGROUND

Different carriers of vehicle interior trim parts are known from the state of the art. Carriers for vehicle interior trim parts are mostly formed from plastic, since plastic provides good mechanical properties with a comparatively low weight. The carrier is often designed in a fiber-reinforced manner, for improving the mechanical characteristics. For this, the carrier for example can contain a fiber non-woven (fleece), which is impregnated by the plastic of the carrier.

Although adequately stable carriers can already be produced by way of this, given a suitably large thickness of the fiber non-woven, however relatively thick and heavy non-wovens are necessary for this. This to an undesirable extent increases the surface weight of the carrier and moreover leads to greater material costs. However, a reduction of the vehicle weight is desirable, in particular with regard to the increasing significance of the reduction of the fuel consumption of motor vehicles.

Moreover, carriers which comprise woven reinforcement materials are known from the field of aircraft technology. Although weight can be saved if woven-fabric-reinforced carriers are used instead of carriers with a reinforcement of non-wovens, woven fabric as a starting material however is too expensive, so that this has not yet gained any significance as a reinforcement material for carriers of vehicle interior trim parts of land vehicles. It is only with aircraft that the advantage of woven-fabric-reinforced carriers is overriding, since here the influence of the weight on the fuel consumption as well as on the design of the remaining components of the aircraft which absorb force is assessed as being significantly more important.

### SUMMARY

It is an object of the invention to develop a carrier for a vehicle interior trim part, which has a reduced surface weight.

This object is achieved by a carrier according to claim 1 as well as by a vehicle interior trim part and a method according to the independent claims. Advantageous further developments and designs are specified in the dependent claims.

The carrier according to the invention comprises a first layer, a second layer as well as a thermoplastic material.

The first layer is formed by a pressed fiber mat, which comprises fibers of a random orientation. A “random orientation” is to be understood in that the fibers run with a random orientation, within a plane of the first layer. The direction of each individual fiber (or the direction component which lies in the plane of the first layer) is random, and the directions of different fibers are not correlated to one another, i.e. the part of the direction vectors of the fibers which lies in the surface plane of the first layer as a whole is statistically distributed considered for all fibers of the first layer. The fibers can also run in a direction which has a direction component orthogonal to the surface plane, but this direction component is however mostly relatively small.

The second layer comprises directed fibers, i.e. the fibers run in one or more preferred directions. The thermoplastic material in particular can penetrate the first as well as the second layer, and connects these to one another and the fibers of the layers amongst one another.

The first layer can have a surface weight which makes up at least 50% of the surface weight of the second layer. This means that the first layer itself contributes significantly to the reinforcement. In particular, the first layer thus at least does not exclusively serve for preventing several plies of a second layer formed in a multi-ply manner from slipping with respect to one another.

A surface weight of the carrier can be smaller than 1400 g/m². In some embodiments, the surface weight of the carrier is smaller than 1200 g/m² or even smaller than 1000 g/m². Such a low surface weight cannot be achieved with conventional carriers reinforced only by a non-woven, without the mechanical characteristics no longer being sufficient for the minimum standards set for vehicle interiors.

A thickness of the carrier (i.e., its dimension in a direction orthogonally to a surface plane of the layers) can for example be less than 2 mm. In some embodiments, the thickness is even smaller than 1.5 mm, smaller than 1.2 mm or smaller than 1 mm.

A maximal tension stress which the carrier withstands without becoming damaged for example can be at least 10 N/mm². Preferably, the maximal tensile stress is at least 20 N/mm² or at least 30 N/mm². A maximal extension of the carrier which is reached before an irreversible deformation (i.e. damage) of the carrier occurs is preferably greater than 0.5% or even greater than 1.2%. A tensile modulus of the carrier for example can be greater than 1000 MPa or even greater than 3500 MPa. The maximal extension, the maximal tensile stress and the tensile modulus can be determined according to DIN EN ISO 527-4 and each relate to the action of a force acting within the surface direction of the carrier.

Polypropylene can be used as a thermoplastic material. This is inexpensive and has an adequately high strength. Of course, most other thermoplasts used for carriers and known from the state of the art can be used as a thermoplastic material of the carrier. Mixtures between different thermoplasts can also be used as a thermoplastic material of the carrier. The thermoplastic material and/or the fibers of the first and/or the second layer can be designed in an opaque manner. Accordingly, the carrier as a whole can be opaque to visible light.

The fibers of the first layer can preferably form a non-woven. Needled non-wovens have been found to be particularly suitable on account of their comparatively high stability. In particular, the non-woven can comprise all fibers of the first layer. The first layer, depending on the embodiment, for example can have between 40 g/m² and 500 g/m² of fibers, wherein only non-thermoplastic fibers have been counted for these values. Fibers of thermoplastic material which possibly have not been completely melted on manufacture of the carrier are thus not counted. The thermoplastic material of the first layer can have between 40 wt % and 85 wt % of the total weight of the first layer, where the sum of the thermoplastic material and the natural fibers of the first layer results in 100 wt %. This results in first layer area weights between 80 g/m² and 2500 g/m². Preferably the distribution between the thermoplastic material and the natural fibers is between 70:30 and 45:55 (thermoplastic material:natural fibers) in the first layer. The term “wt %” throughout this application usually refers to the surface weight, i.e. 50 wt % refers to the material contributing to 50% of the surface weight. Most percentages “%” referred to in this application refer to the weight, unless obviously referring to an extension, elongation or indentation, or an area or length.

The fibers of the second layer can form a woven fabric. A product of at least two thread systems which are crossed at right angles or almost at right angles is indicated as a woven fabric in some embodiments. The woven according to one embodiment can comprise all fibers of the second layer. However, a multi-ply second layer is also conceivable, wherein only one ply of the first layer forms a woven fabric. The woven fabric according to one embodiment can have an overlapping degree of more than 50%, i.e. possible holes between the woven fabric fibers have a surface share of less than 50%. The overlapping degree can even be above 70% or above 90% depending on the embodiment. In some embodiments, the overlapping degree is more that 95%, i.e. the surface share of possible holes between woven fabric fibers in such embodiments is smaller than 5%.

The second layer instead of a woven fabric can also comprise a knitted fabric (i.e. a textile product with which a loop formed by way of threads is entwined into another loop) or a specific knitted fabric. The second layer can likewise be composed of at least one woven fabric and/or at least one knitted fabric and/or at least one specific knitted fabric.

The fibers of the second layer can likewise at least partly form a layer of unidirectionally running fibers. In particular, the second layer can compromise at least two plies which are each formed by unidirectional fibers. The fibers of the first ply can run an angle, in particular a right angle, to the fibers of the second ply. Even if the layer comprises not only two, but any natural number n of plies, adjacent plies can each comprise unidirectional fibers which are rotated to one another about an angle of 360°/n or X·360°/n (wherein X is a natural number which is <n). A particularly uniform loading of the fibers independently of the load direction can be achieved by way of this.

The second layer, depending on the embodiment, can have between 50 g/m² and 600 g/m² of fibers, independently of the arrangement of the fibers, wherein only non-thermoplastic fibers are counted for these values. Fibers of thermoplastic material which are possibly not completely melted on manufacture of the carrier are thus not counted. Preferably, natural fibers of the second layer comprise between 40 wt % and 100 wt % of the second layer, and the remaining weight includes or is made up from the thermoplastic material.

The fibers of the first and/or the second layer in particular can be formed from a natural material. Bast fibers, such as flax, jute, hemp, bamboo, papyrus or kenaf have been found to be particularly suitable. Hard fibers such as coconut fibers or sisal can likewise be used as fibers of the first and/or second layer. Seed fibers such as cotton can likewise be used for example.

The thermoplastic material can have a weight share of 20% to 80% of the carrier depending on the embodiment. It has been found to be particularly suitable if the weight share of the thermoplastic material is between 30% and 70% or between 40% and 60%. The thermoplastic material for example can have a weight share of 50% with regard to the carrier. The fibers can likewise have a weight share of 50% with regard to the carrier.

The weight share of the thermoplastic material with regard to the carrier can be essentially constant over the carrier. Alternatively, the weight share of the thermoplastic material of the first layer can differ from a weight share of the thermoplastic material of the second layer. In particular, the second layer (i.e. the layer with the aligned fibers) can have a lower weight share of thermoplastic material than the first layer.

In one embodiment, the carrier essentially consists only of thermoplastic material and fibers (in particular only of thermoplastic material and natural fibers). The summed weight share of fibers and material can accordingly be greater than 95%, greater than 98% or greater than 99%. In particular, the weight share can be about 100%, i.e., according to such embodiments only impurities present in traces are present as remaining constituents. In a further embodiment, the summed weight share of the natural fibers and the thermoplastic materials is greater than 95 wt %, greater than 98% or about 100% of the weight of the carrier.

The carrier additionally to the at least one first layer and the at least one second layer can comprise reinforcement structures, for example ribs, which are injected on (integrally injected) and consist of thermoplastic material (for example polypropylene). These can be selectively injected on the first or second layer, and specifically on the side which is away from the respective other layer. Likewise, the carrier can comprise one or more injected-on functional elements, for example holders and/or crash-cones. The functional elements can partly or completely consist of a thermoplastic material and be selectively injected on the first or second layer.

The invention moreover relates to a vehicle interior trim part which comprises a carrier as is designed as previously described. The vehicle interior trim part moreover comprises at least one decor layer which forms a viewed or exposed side of the vehicle interior trim part and completely covers the carrier. The decor layer, depending on the embodiment, can be designed in a single-part or multi-part manner and can consist of any decor materials for vehicle interior trim parts which are known from the state of the art. The decor layer can be formed for example from leather, artificial leather or a plastic mould skin. An intermediate layer can be arranged between the carrier and the decor layer either regionally or over the whole surface, and this intermediate layer in particular as a haptics layer can serve for producing soft haptics. The intermediate layer in particular can consist of a knitted fabric or a foam layer.

The invention moreover relates to a method for manufacturing a carrier, additionally to a carrier and a vehicle interior trim part.

According to a first step of the method, firstly a first mat and a second mat are arranged in or on a tool. The first mat comprises fibers of a random orientation, wherein the significance of the term “random orientation” is such as is already explained in the context of the carrier. The second mat comprises fibers, which are spatially aligned, i.e. the fibers run mainly in one or several (for example one or two) directions. Both mats have at least a few fibers which consist of a non-thermoplastic material. Moreover, at least one of the two mats comprises a thermoplastic material or an additional layer of a thermoplastic material is present. A surface weight of the first mat for example can be at least 50% of the surface weight of the second mat.

In a subsequent method step, the mats are pressed against one another by way of the tool, wherein moreover heat is incorporated into the first and/or second mat. The thermoplastic material melts on account of the heat. The mats are compacted by way of the pressure and the molten thermoplastic material is forced into the remaining cavities between the non-thermoplastic fibers, by which mean these are filled. In this method step, the mats are fixedly connected to one another. Of course, the mats can already be pre-fixed beforehand, for example in order to prevent a slipping of the mats to one another, before the pressing.

The surface weight of the first mat for example can be more than 80%, more than 100% or even more than 120% of the surface weight of the second mat. If the surface weight of the first mat is relatively large compared to the second mat, then only a second mat having a relatively low surface weight is necessary. This is advantageous since the second mat comprises the aligned fibers and therefore is mostly more expensive given the same weight.

A total thickness of the mats before the pressing step for example can be between 5 mm and 30 mm. According to one embodiment example, the total thickness is between 10 mm and 20 mm.

According to one embodiment, the thermoplastic material, before pressing the mats against one another, is present at least partly as fibers or a constituent of fibers in one or both mats. Likewise however, one or both mats can also be impregnated with the thermoplastic material. Likewise, also one of the mats can comprise thermoplastic fibers, whereas the other mat is impregnated with a thermoplastic. One can also envisage one or both mats comprising thermoplastic fibers as well as being impregnated with a thermoplastic (wherein this variant tends to be applied quite rarely due to the increased effort for incorporating the thermoplastic into the mats).

According to a further embodiment, the thermoplastic material before pressing the mats against one another, is present as at least one thermoplastic foil, which is arranged between the first and the second mat, on the side of the first mat which is away from the second mat and/or on the side of the second mat which is away from the firsts mat. Likewise, the application of a thermoplastic foil can also be combined with the use of thermoplastic fibers in the first and/or second mat and/or with the use of one or more mats impregnated with thermoplastic.

The following specifications with regard to the mats relate to the mats before the pressing. The subsequently specified surface weights include the weight of the thermoplastic material which is contained in the respective mat as the case may be, and therefore differ from the surface weights specified above for the fibers in the carrier. At this location, it is to be noted that the mats do not need to be designed in a coherent manner. On the contrary, it is likewise possible for the first and/or second mat to also be composed of several separate layers which are not fastened on one another. In this case, the details specified below relate to the complete mat consisting of several layers. Of course, the mats however can also be designed in each case in a single-layered manner, and all details regarding the mats and specified below are valid as explicitly disclosed also in the context of single-layered mats.

The first mat for example can have a surface weight of between 200 g/m² and 1000 g/m². In some embodiments the surface weight of the first mat is between 400 g/m² and 800 g/m². The first layer for example can comprise between 50% and 80% thermoplastic material and between 50% and 20% non-thermoplastic fibers.

The second mat for example can have a surface weight between 100 g/m² and 600 g/m².

In some embodiments, the surface weight of the second mat is between 200 and 450 g/m². The second mat for example can comprise between 0 and 50% thermoplastic material and between 100% and 50% non-thermoplastic fibers.

### BRIEF DESCRIPTION OF THE DRAWINGS

Embodiment examples of the invention are explained hereinafter in more detail. There are shown in:

FIG. 1a to 1c—a cross section through a tool for manufacturing a carrier, at different points in time of a manufacturing method of a carrier,

FIG. 2a—a cross section through a first embodiment of a carrier,

FIG. 2b—a section within the surface plane of the second layer of the carrier of FIG. 2a,

FIG. 2c—a cross section through a second embodiment of a carrier,

FIGS. 2d and 2e—cross sections through a first and second ply of the second layer of the carrier of FIG. 2c,

FIG. 3a—a diagram, with which reading pairs of surface weight of the carrier and of the maximal tensile stress of the carrier are represented for different carriers according to the invention, as well as for carriers designed according to the state of the art,

FIG. 3b—a diagram, with which reading pairs of surface weight of the carrier and of the maximal tensile extension of the carrier are represented for different carriers according to the invention, as well as for carriers designed according to the state of the art,

FIG. 3c—a diagram, with which reading pairs of surface weight of the carrier and of the modulus of elasticity of the carrier are represented for different carriers according to the invention, as well as for carriers designed according to the state of the art,

FIG. 4—one embodiment example of a vehicle interior trim part.

### DETAILED DESCRIPTION OF THE ILLUSTRATED EMBODIMENTS

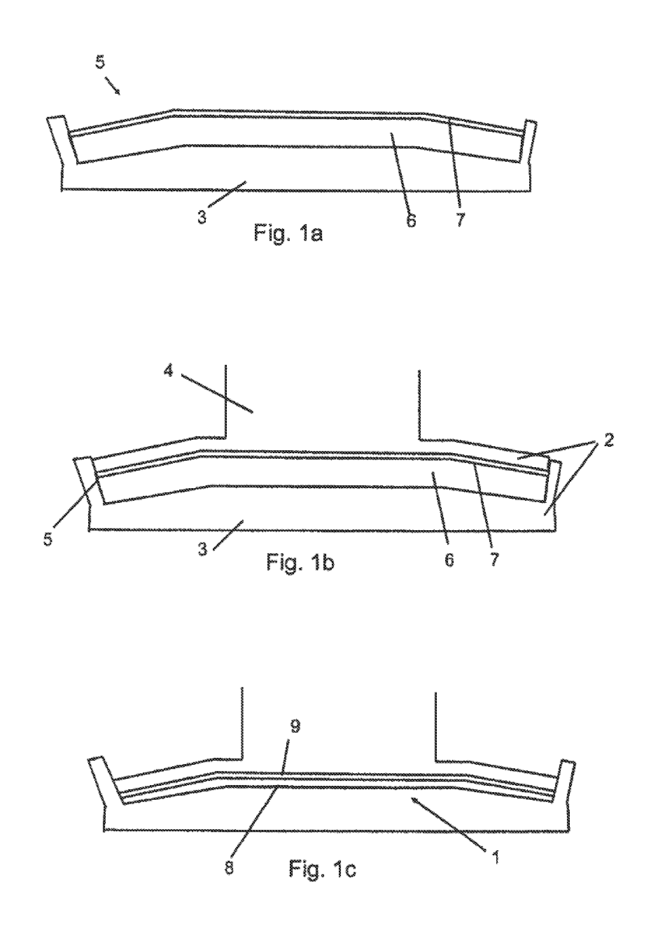

A tool 2 for manufacturing a carrier 1 is represented in the FIGS. 1a to 1c. The tool in the represented embodiment example of the method comprises a lower part 3 and an upper part 4 which together border around a cavity 5 which can be reduced in size by way of displacing the upper part 4. A first mat 6 and a second mat 7 are arranged in the cavity 5 in a first method step.

The first mat 6 in this embodiment example is designed as a non-woven of 50% weight share of polypropylene fibers and 50% weight share of flax fibers and has a surface weight of 600 g/m². The second mat 7 is designed as a woven fabric of flax fibers, which is impregnated with polypropylene. The flax fibers hereby have a weight share of 50% of the second mat 7. The polypropylene likewise has a weight share of 50% of the second mat 7. A surface weight of the second mat 7 is 400 g/m². The upper tool part 4 is applied onto the second mat 7 in a second method step. The mats 6, 7 are subsequently pressed against one another and are thereby compressed. At the same time, the mats 6, 7 are heated by way of tool 2, so that the polypropylene contained in the mats 6, 7 melts (this would function in the same manner with another thermoplastic material, as long as the melting point of the thermoplastic material is lower than a temperate which is maximally compatible with regard to the flax fibers). The mats 6, 7 which in the condition represented in FIG. 1a as a whole have a thickness of 15 mm are compressed by way of this to a total thickness of about 1 mm. The melted polypropylene thereby fills the remaining cavities between the fibers and moreover connects the two mats 6, 7.

At this location, it is to be noted that amongst other things, the tool is only represented in a schematic manner. Such tools are known within the state of the art and any tools which are suitable for shaping and with which fiber mats can be compressed and heated can be used for the method. The tool can comprise diverse further features which are known per se from the state of the art, such as for example suction openings (for sucking the air which prevails in the mats at the beginning) or injection openings for injecting plastic ribs.

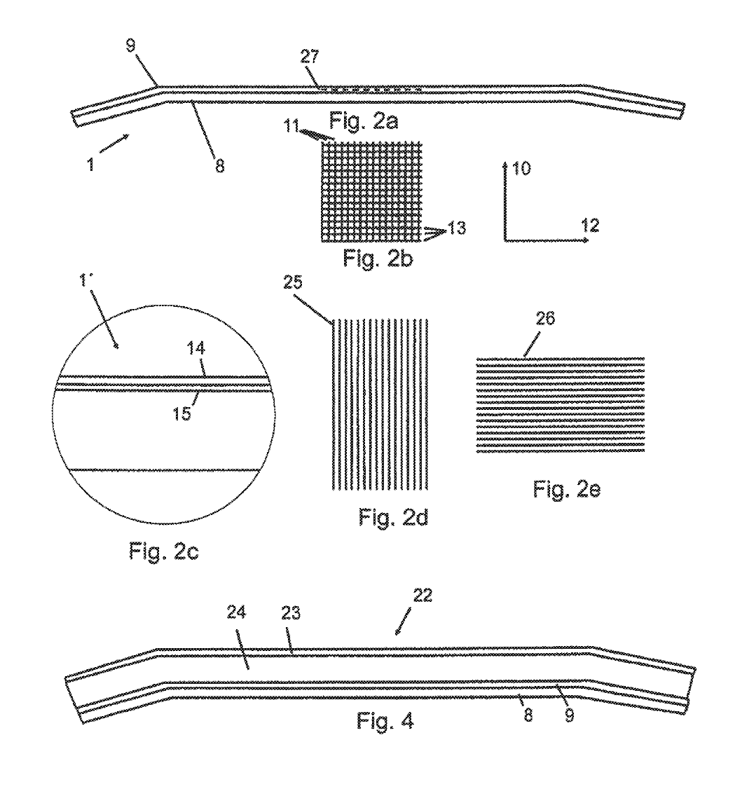

As a whole, the carrier 1 as is represented in FIG. 2 is formed by the previously described method. The carrier comprises a first layer 8 and a second layer 9, wherein the first layer 8 has arisen from the first mat 6 and the second layer 9 from the second mat 7. The first layer 8 is designed as a compressed needled non-woven whose cavities are essentially completely filled with polypropylene. The second layer 9 is designed as a woven textile layer, wherein the cavities of the woven fabric are likewise filled with polypropylene. Additionally, the carrier comprises reinforcement ribs which are injected onto the underside of the first layer 8. The carrier as a whole has a surface weight of about 1100 g/m². A maximal tensile stress of the carrier is roughly 54 N/mm². A maximal extension is about 4.2% and the modulus of elasticity is about 3900 MPa. In this embodiment the first mat can for example be a non-woven mat having 50 wt % natural fibers and 50 wt % thermoplastic material. The second mat may be for example be an all natural fiber woven or unidirectional natural fiber mat, or a woven natural fiber material, where the natural fibers are impregnated with a thermoplastic material, for example polypropylene (PP). Alternatively the second mat may include interweaved natural fibers, for example flax, and thermoplastic fibers. The ratio between the natural fibers and the thermoplastic material of the second mat may be for example 50:50 in weight.

If one considers a sectioned view through the carrier within the surface plane of the second layer 9 (cf. FIG. 2b), one can recognize that this continues to have its woven textile structure with first thread sections 11 running in a first direction 10 and second thread sections 13 running in the second direction 12. Only a detail of such a sectioned view is represented in FIG. 2b, wherein the region represented in the detail in FIG. 2a is indicated by a dashed line 27.

A second embodiment of a carrier 1′ is represented in the FIGS. 2c to 2e and this differs from the carrier 1 of FIG. 2a in particular in that the second layer 9′ is formed in a two-ply manner with a first ply 14 and a second ply 15. The carrier in FIG. 2c is represented in a section running orthogonally to its surface direction. FIG. 2d shows a section within the surface plane of the first ply 14. FIG. 2e shows a section within the surface plane of the second ply 15. Both plies 14, 15 in each case have unidirectional flax fibers, wherein the fibers 25 of the first ply 14 run at angles (preferably orthogonally) to the fibers 26 of the second ply 15.

The carrier was manufactured of two mats in a similar manner. The first mat in this embodiment example was formed as a non-woven with a surface weight of 750 g/m², a polypropylene share of 70% and a natural fiber share of 30%. The second mat before the pressing consisted of two plies/layers separate to one another and which in each case consisted of unidirectional flax fibers and had a surface weight in each case of 125 g/m² (i.e. the second mat has a surface weight of 250 g/m²). The second mat contains no thermoplastic material. Both plies were arranged over one another and specifically in a manner such that the fiber directions of the flax fibers of both plies were aligned orthogonally to one another. Otherwise the method took its course in the same manner, as described by way of FIG. 1. In a further example the first mat is a non-woven mat consisting of natural fibers, such as hemp, sisal or cotton, and polypropylene in a ration of 50:50 in weight. The surface weight of the first mat is chosen to be 600 g/m². The second mat can be, for example a woven mat made from natural fibers only. For example, the second mat can be a woven mat (e.g. hemp mat) with a surface weight between 125 g/m2 and 250 g/m2. When forming the carrier, the thermoplastic material of the first mat may penetrate the second mat as well. As an alternative to the all natural fiber woven, second mat, said second mat may include both natural fibers and thermoplastic material in a ratio chosen from the interval of 99:1 to 40:60, preferably 60:40 to 40:60. In these cases the thermoplastic material of the first and second mats helps binding the two mats. The thermoplastic material can be part of the second mat by impregnating the natural fibers and weaving the impregnated natural fibers or the natural fibers are woven with thermoplastic fibers into a fabric. The natural fibers may be arranged such that two or more natural fibers are separated by a thermoplastic fiber. A further example of a second mat is a mat consisting of a unidirectional natural fiber mat of a surface weight of 100 g/m². Alternatively, the natural fibers can be interspersed with thermoplastic fibers. The ratios between the natural fibers and the thermoplastic material may then be chosen from the interval of 99:1 to 40:60, preferably 60:40 to 40:60. These combinations, among other combinations in this application, have improved properties regarding breakage and splintering compared to prior art materials such as carrier including only a non-woven or carriers made from a wood composite, both of which have a much higher surface weight then the described combinations.

The thus formed carrier represented in FIGS. 2c to 2e has a surface weight of about 1000 g/m². The maximal tensile stress is more than 35 N/mm².

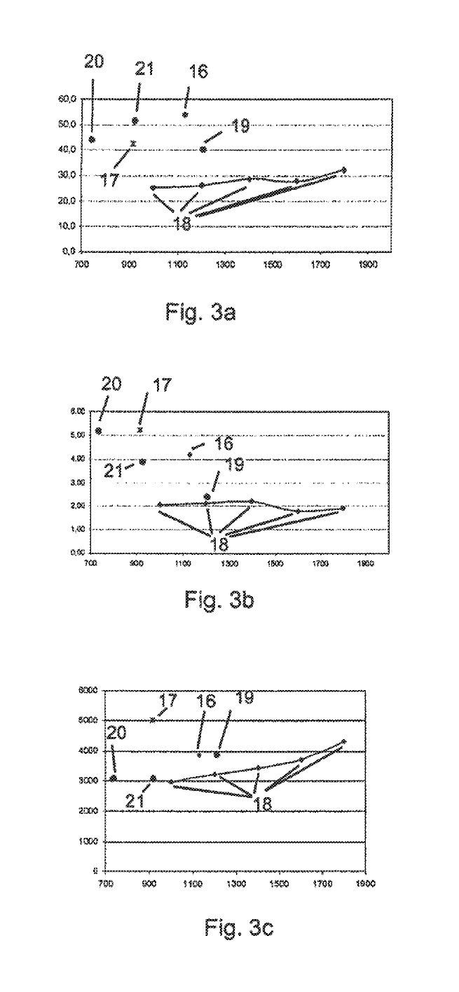

In each case, the surface weight in g/m² is plotted on the horizontal axis in the FIGS. 3a to 3c. The maximal tensile stress in N/mm² (FIG. 3a), the maximal tensile extension in % (FIG. 3b) and the modulus of elasticity in MPa (FIG. 3c) are plotted on the vertical axis. Points which each represent value pairs for embodiments of carriers according to the invention (see points 16 and 17) or value pairs for carriers of the state of the rat (see points 18 to 21) are marked in the diagrams. The points indicated at 16 mark value pairs of the carrier of FIG. 2a. The points indicated at 17 mark value pairs for a carrier which differs from the carrier of FIG. 2a to the extent that a more lightweight second mat was used, which—instead of having thermoplastic fibers—was impregnated with a thermoplastic material.

The points 18 represent conventional carriers of pressed fiber non-woven containing thermoplastic. The line which connects the points 18 represents an approximation between the actually measured points. The points 19 represented the value pairs for a fiber non-woven which is pressed in a similar manner, is of a particularly high quality, is fine-fibered and contains thermoplastic. As can be recognized, the mechanical characteristics are not very good (i.e. the maximal tensile stress is only greater than 35 N/mm² at high surface weights) for the carriers which are only manufactured from non-woven fabric.

The points 20 and 21 relate to a woven mat which contains thermoplastic fiber or is impregnated with thermoplastic respectively, said mat having been pressed and heated in the same manner. As is to be recognized, the mechanical characteristics, in particular the maximal tensile stress is satisfactory. However, the price for such a carrier is unacceptably high since the mats however consist completely of woven material.

A vehicle interior trim part 22 which comprises the carrier 1 of FIG. 2a is represented in FIG. 4. Additionally, the vehicle interior trim part 22 yet comprises a decor layer 23 of leather as well as a foamed intermediate layer 24. The decor layer forms the viewed side of the vehicle interior trim part and completely covers the carrier 1. In the shown embodiment example, the second layer 9 of the carrier 1 faces the intermediate layer 24. The carrier 1 however can also be arranged the other way round, in a manner such that the first layer 8 faces the intermediate layer, and the second layer 9 is arranged on the side of the carrier 1 which is away from the intermediate layer 24.

1. A carrier comprising at least one thermoplastic material, at least one first layer which is formed from a pressed fiber mat and includes fibers of a random orientation, and at least one second layer with aligned fibers.

2. A carrier according to claim 1, wherein the first layer has a surface weight which is at least 50% of a surface weight of the second layer.

3. A carrier according to claim 1, wherein the carrier has a surface weight which is smaller than 1400 g/m²

4. A carrier according to claim 1, wherein the carrier has a surface weight which is smaller than 1200 g/m²

5. A carrier according to claim 1, wherein the carrier has a surface weight which is smaller than 1000 g/m².

6. A carrier according to claim 1, wherein the second layer comprises at least two plies of unidirectionally running fibers, wherein the unidirectional fibers of one of the two plies run at angles to the unidirectional fibers of the other of the two plies.

7. A carrier according to claim 1, wherein at least some of the fibers of the first and/or second layer are formed from natural fibers comprising bast fibers, hard fibers, seed fibers, or any combination of bast, hard, and seed fibers.

8. A carrier according to claim 7, wherein any bast fibers in the carrier are fibers of flax, jute, hemp, bamboo, papyrus, and/or kenaf, any hard fibers in the carrier are sisal fibers or fibers of coconut, and any seed fibers in the carrier are cotton fibers.

9. A carrier according to claim 1, wherein the thermoplastic material has a weight share of 20% to 80% with regard to the carrier.

10. A carrier according to claim 1, wherein the thermoplastic material has a weight share of 40% to 60% with regard to the carrier.

11. A carrier according to claim 1, wherein the carrier comprises at least 95% of fibers and thermoplastic material.

12. A carrier according to claim 1, wherein the carrier comprises at least 95 wt % of natural fibers and thermoplastic material.

13. A carrier according to claim 1, including at least one reinforcement structure comprising a reinforcement rib and/or at least one functional element, wherein the reinforcement fiber and/or the functional element are at least partly are formed from the thermoplastic material or another thermoplastic material.

14. A vehicle interior trim part comprising a carrier according to claim 1, and a decor layer, wherein the decor layer forms a viewed side of the vehicle interior trim part and completely covers the carrier.

15. A method for manufacturing a carrier for a vehicle interior trim part, comprising the steps:
arranging at least one first mat of fibers of a random orientation and at least one second mat of aligned fibers, in or on a tool, wherein at least some of the fibers in the first and second mat are formed from a non-thermoplastic material, wherein the first and/or the second mat and/or a further layer arranged in or on the tool additionally to the first and second mat, comprises a thermoplastic material; and
pressing together the first and second mat in the presence of heat such that the thermoplastic material melts and the mats connect to one another.

16. A method according to claim 15, wherein:
the thermoplastic material at least partly is integrated as fibers in the first and/or second mat;
the first and/or the second mat is impregnated with the thermoplastic material; and/or
a foil comprising the thermoplastic material as a further layer is arranged between the first and second mat and/or on a side of the first mat which is away from the second mat and/or on a side of the second mat which is away from the first mat.

17. A method according to claim 15, wherein a first mat is used which has a surface weight of 200 g/m² to 1000 g/m²

18. A method according to claim 15, wherein a first mat is used which has a surface weight of 400 g/m² to 800 g/m².

19. A method according to claim 15, wherein a second mat is used which has a surface weight between 100 g/m² and 600 g/m²

20. A method according to claim 15, wherein a second mat is used which has a surface weight between 200 g/m² and 450 g/m².
